(19) United States
(12) Patent Application Publication
(10) Pub. No.: US 2025/0310210 A1
(43) Pub. Date: Oct. 2, 2025

(54) APPARATUS AND METHOD FOR MEASURING ENERGY CONSUMPTION OF USER EQUIPMENT IN WIRELESS COMMUNICATION SYSTEM

(71) Applicant: ELECTRONICS AND TELECOMMUNICATIONS RESEARCH INSTITUTE, Daejeon (KR)

(72) Inventors: Changki KIM, Daejeon (KR); Jeoung Lak HA, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 19/091,283

(22) Filed: Mar. 26, 2025

(30) Foreign Application Priority Data
Mar. 27, 2024 (KR) 10-2024-0041866
Apr. 3, 2024 (KR) 10-2024-0045252
Sep. 20, 2024 (KR) 10-2024-0127643
Jan. 14, 2025 (KR) 10-2025-0005325
Feb. 14, 2025 (KR) 10-2025-0019296
Mar. 26, 2025 (KR) 10-2025-0038893

(51) Int. Cl. H04L 41/14; H04W 24/08

(52) U.S. Cl. CPC H04L 41/14; H04W 24/08

(57) ABSTRACT

The present disclosure generally relates to wireless communication systems, and more particularly, to an apparatus and method for measuring energy consumption of user equipment in a wireless communication system. Specifically, a Session Management Function (SMF) receives an SMF event subscription for requesting user data volume(s) and additional information of energy consumption measurement target information of a UE from an Energy Information Function (EIF) or Network Data Analytics Function (NWDAF) through a Service Based Interface (SBI). The SMF extracts a gNB ID from user location information received from an Access and Mobility Management Function (AMF). The SMF transmits to a User Plane Function (UPF) through the SBI via UPF event subscription or through an N4 interface to obtain user data volume(s). After receiving user data volume(s) and additional information from the UPF, the SMF can transmit information for UE energy consumption calculation including these to the EIF or NWDAF.

### CROSS-REFERENCE TO RELATED APPLICATIONS

This application claims priority to Korean Patent Application No. 10-2024-0041866, filed on Mar. 27, 2024, Korean Patent Application No. 10-2024-0045252, filed on Apr. 3, 2024, Korean Patent Application No. 10-2024-0127643 filed on Sep. 20, 2024, Korean Patent Application No. 10-2025-0005325 filed on Jan. 14, 2025, Korean Patent Application No. 10-2025-0019296 filed on Feb. 14, 2025, Korean Patent Application No. 10-2025-0038893 filed on Mar. 26, 2025, the entire contents of which are hereby incorporated by reference.

### BACKGROUND OF THE INVENTION

### Field of the Invention

The present disclosure generally relates to wireless communication systems, and more particularly, to an apparatus and method for measuring energy consumption of user equipment in a wireless communication system.

### Description of the Related Art

In wireless communication systems, particularly 5G systems (5GS), energy efficiency has emerged as an important consideration. The 3GPP SA2, a major mobile communication standardization organization, conducted a selection process for Rel-19 Study Items in the second half of 2023, sequentially began Rel-19 Studies from October 2023, and completed the draft of Normative standard specifications at stage 2 level by December 2024. Currently, the Rel-19 maintenance phase and Rel-20 Study Item phase are in progress.

According to the current Rel-19 standard specifications, a new network function (NF) called Energy Information Function (EIF) has been added to measure and expose energy consumption (EC) for improving energy efficiency of User Equipment (UE), Radio Access Network (RAN), and core network (CN) function nodes in 5G systems.

Prior to Rel-19, there was no standardization related to 5GS energy efficiency, thus the existence of a logical network function for calculating and exposing energy consumption of 5GS systems was not necessary. However, in Rel-19, a new logical network function, EIF, has been added, and as another approach, adding energy consumption calculation and exposure functions to the existing Network Data Analytics Function (NWDAF) is also being considered.

The EIF or NWDAF must collect user data volume(s) and additional information (gNB ID, UPF ID, measurement time information) of energy measurement target information (UE, PDU Session, or Application ID, Data Flow) from the Session Management Function (SMF) with measurement time information (measurement time and measurement period T), and must collect energy consumption of the RAN and UPF to which the UE belongs from the OAM (Operation Administration Maintenance) during the same measurement time information.

### SUMMARY OF THE INVENTION

The present disclosure provides an apparatus and method for efficiently measuring energy consumption of User Equipment (UE) in a wireless communication system.

Additionally, the present disclosure provides an apparatus and method for the Session Management Function (SMF) to receive requests from the Energy Information Function (EIF) or Network Data Analytics Function (NWDAF) for user data volume(s) and additional information needed to calculate UE energy consumption, collect this information through the User Plane Function (UPF), and provide the results to the EIF or NWDAF.

Furthermore, the present disclosure provides an apparatus and method for the UPF to collect user data volume(s) and additional information for measuring UE energy consumption and provide the results to the SMF, EIF, or NWDAF.

According to various embodiments of the present disclosure, a method of operating a Session Management Function (SMF) for measuring energy consumption (EC) of a user equipment (UE) in a wireless communication system includes: receiving, from an Energy Information Function (EIF) or Network Data Analytics Function (NWDAF) through a Service Based Interface (SBI), an SMF event subscription for requesting user data volume(s) and additional information of energy consumption measurement target information of the UE; extracting a gNodeB (gNB) ID to which the energy consumption measurement target information belongs from user location information received from an Access and Mobility Management Function (AMF); transmitting to a User Plane Function (UPF) including the gNB ID through the SBI via UPF event subscription or through an N4 (Packet Forwarding Control Protocol, PFCP) interface based on information received from the EIF to obtain user data volume(s) of the energy consumption measurement target information; receiving user data volume(s) and additional information from the UPF; and transmitting the information received from UPF for calculating UE-related energy consumption to the EIF or NWDAF.

According to various embodiments of the present disclosure, a method of operating a User Plane Function (UPF) for measuring energy consumption (EC) of a user equipment (UE) in a wireless communication system includes: receiving, from a Session Management Function (SMF) through a Service Based Interface (SBI) via UPF event subscription or through an N4 (Packet Forwarding Control Protocol, PFCP) interface, a request to collect user data volume(s) of energy consumption measurement target information of the UE; collecting user data volume(s) using an event identifier (Event ID), measurement target information, and a gNodeB (gNB) identifier (ID) received from the SMF; transmitting the user data volume(s) and additional information through a UPF event exposure (Nupf_EventExposure) service interface to the SMF or directly to an Energy Information Function (EIF) or Network Data Analytics Function (NWDAF); and directly receiving a request for user data volume(s) and additional information of the measurement target information from the EIF or NWDAF through the UPF event exposure (Nupf_EventExposure) service interface, collecting user data volume(s) according to the event, and directly transmitting the results through the UPF event exposure (Nupf_EventExposure) service interface to the EIF or NWDAF.

According to various embodiments of the present disclosure, an SMF for measuring energy consumption of a user equipment in a wireless communication system includes a transceiver and a controller operably connected to the transceiver, wherein the controller is configured to: receive, from an Energy Information Function (EIF) or Network Data Analytics Function (NWDAF) through a Service Based Interface (SBI), an SMF event subscription for requesting user data volume(s) and additional information of energy consumption measurement target information of the UE; extract a gNodeB (gNB) ID to which the energy consumption measurement target information belongs from user location information received from an Access and Mobility Management Function (AMF); transmit to a User Plane Function (UPF) including the gNB ID through the SBI via UPF event subscription or through an N4 interface based on information received from the EIF to obtain user data volume(s) of the energy consumption measurement target information; receive user data volume(s) and additional information from the UPF; and transmit the information received from the UPF for calculating UE-related energy consumption to the EIF or NWDAF.

According to various embodiments of the present disclosure, a UPF for measuring energy consumption of a user equipment in a wireless communication system includes a transceiver and a controller operably connected to the transceiver, wherein the controller is configured to: receive, from a Session Management Function (SMF) through a Service Based Interface (SBI) via UPF event subscription or through an N4 interface, a request to collect user data volume(s) of energy consumption measurement target information of the UE; collect user data volume(s) using an event identifier (Event ID), measurement target information, and a gNodeB (gNB) identifier (ID) received from the SMF; transmit the user data volume(s) and additional information through a UPF event exposure (Nupf_EventExposure) service interface to the SMF or directly to an Energy Information Function (EIF) or Network Data Analytics Function (NWDAF); and directly receive a request for user data volume(s) and additional information of the measurement target information from the EIF or NWDAF through the UPF event exposure (Nupf_EventExposure) service interface, collect user data volume(s) according to the event, and directly transmit the results through the UPF event exposure (Nupf_EventExposure) service interface to the EIF or NWDAF.

### BRIEF DESCRIPTION OF THE DRAWINGS

FIG. 1 illustrates a service-based 3GPP 5G system architecture according to various embodiments of the present disclosure.

FIG. 2 illustrates a procedure for collecting data for energy consumption measurement of measurement target information according to an embodiment of the present disclosure.

FIG. 3 illustrates event identifiers (Event IDs) and event filter information for SMF event exposure according to an embodiment of the present disclosure.

FIG. 4A and FIG. 4B illustrate UPF event exposure service operations with additional information for UE energy consumption measurement according to an embodiment of the present disclosure.

FIG. 5 illustrates a direct UPF event exposure service processing procedure for UE energy consumption measurement according to an embodiment of the present disclosure.

FIG. 6 is a flowchart illustrating a method of operating a Session Management Function (SMF) for measuring energy consumption of a user equipment (UE) in a wireless communication system according to an embodiment of the present disclosure.

FIG. 7 is a flowchart illustrating a method of operating a User Plane Function (UPF) for measuring energy consumption of a user equipment (UE) in a wireless communication system according to an embodiment of the present disclosure.

FIG. 8A illustrates an initialization procedure between UPF and SMF including energy efficiency enhancement function support information according to an embodiment of the present disclosure.

FIG. 8B illustrates energy efficiency enhancement function related information elements exchanged in the initialization procedure between UPF and SMF according to an embodiment of the present disclosure.

FIG. 9A illustrates a registration procedure of a User Plane Function (UPF) with energy efficiency enhancement functions with the Network Repository Function (NRF) according to an embodiment of the present disclosure.

FIG. 9B illustrates a procedure between a Consumer Network Function (Consumer NF) and a Network Repository Function (NRF) for discovering a User Plane Function (UPF) that provides energy efficiency enhancement functions according to an embodiment of the present disclosure.

FIG. 10 is a flowchart illustrating a method for the User Plane Function (UPF) to support energy efficiency enhancement and energy saving of the network in a 5G system (5GS) according to an embodiment of the present disclosure.

FIG. 11 is a flowchart illustrating a method for the Network Repository Function (NRF) to support energy efficiency enhancement and energy saving of the network in a 5G system (5GS) according to an embodiment of the present disclosure.

FIG. 12 illustrates a configuration of a network entity in a wireless communication system according to various embodiments of the present disclosure.

FIG. 13 illustrates a configuration of a user equipment in a wireless communication system according to various embodiments of the present disclosure.

### DETAILED DESCRIPTION OF THE EMBODIMENTS

The terms used in the present disclosure are used only to describe specific embodiments and are not intended to limit the scope of other embodiments. Unless the context clearly indicates otherwise, singular expressions may include plural expressions. Technical or scientific terms, including those used herein, may have the same meanings as commonly understood by those skilled in the art to which the present disclosure belongs. Terms defined in general dictionaries may be interpreted to have meanings identical or similar to their contextual meanings in the relevant art and are not to be interpreted in an idealistic or overly formal sense unless expressly defined otherwise in the present disclosure.

In the various embodiments of the present disclosure described below, hardware approaches are exemplified. However, since the various embodiments of the present disclosure include technologies that use both hardware and software, the present disclosure does not exclude software-based approaches.

Furthermore, in the detailed description and claims of the present disclosure, “at least one of A, B, and C” may mean “only A”, “only B”, “only C”, or “any combination of A, B, and C”. Also, “at least one of A, B, or C” or “at least one of A, B, and/or C” may mean “at least one of A, B, and C”.

Hereinafter, the present disclosure relates to an apparatus and method for measuring energy consumption of user equipment in a wireless communication system. Specifically, the present disclosure describes technology for measuring energy consumption (EC) of user equipment (UE) in a wireless communication system.

More specifically, the present disclosure provides a method for the EIF or NWDAF to request and collect necessary data from the SMF and OAM to measure UE energy consumption, facilitating the measurement of UE-related energy consumption in 5G systems.

The terms used to designate signals, channels, control information, network entities, and components of the device in the following description are exemplified for convenience. Therefore, the present disclosure is not limited to the terms described below, and other terms with equivalent technical meanings may be used.

In addition, although the present disclosure describes various embodiments using terms used in some communication standards (e.g., 3GPP (3rd Generation Partnership Project)), these are just examples for explanation. The various embodiments of the present disclosure can be readily modified and applied to other communication systems.

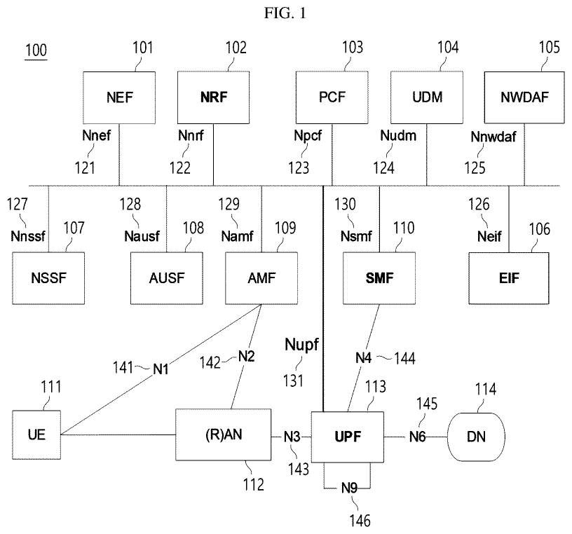

Referring to FIG. 1, a service-based 3GPP 5G system architecture (100) according to various embodiments of the present disclosure is illustrated. The 5G system architecture (100) includes a Network Exposure Function (NEF) (101), a Network Repository Function (NRF) (102), a Policy Control Function (PCF) (103), a Unified Data Management (UDM) (104), a Network Data Analytics Function (NWDAF) (105), an Energy Information Function (EIF) (106), a Network Slice Selection Function (NSSF) (107), an Authentication Server Function (AUSF) (108), an Access and Mobility Management Function (AMF) (109), a Session Management Function (SMF) (110), a User Equipment (UE) (111), a Radio Access Network (RAN) (112), a User Plane Function (UPF) (113), and a Data Network (DN) (114).

As shown in FIG. 1, the UPF (113) is connected to the SBA (Service Based Architecture) structure of the control plane with an SBI (Service Based Interface) interface (131) called Nupf, in addition to the N4 interface (144) with the SMF (110). Furthermore, a new function node for energy consumption (EC) measurement and exposure, EIF (106) or NWDAF (105), and related SBI interfaces (126, 125) are included.

Prior to Rel-19, there was no standardization related to 5GS energy efficiency, thus the existence of a logical network function (NF) (e.g., EIF (106)) to expose energy consumption calculations of the 5GS system was not necessary. According to the ongoing standardization work for Rel-19, a new logical NF, EIF (106), has been added. There is also another approach to add energy consumption calculation and exposure functions to the existing NWDAF (105).

The EIF (106) or NWDAF (105) must collect user data volume(s) and additional information (gNB ID, UPF ID, measurement time information) of energy measurement target information (UE, PDU Session, Application ID, or Data Flow) from the SMF (110) with measurement time information (measurement time and measurement period T), and must collect energy consumption of the RAN (112) and UPF (113) to which the UE (111) belongs from the OAM during the same period.

Therefore, the present disclosure provides a method for the EIF (106) or NWDAF (105) to collect user data volume(s) and additional information of energy measurement target information from the SMF (110) for measuring UE (111) energy consumption, and a method to collect energy consumption of the RAN (112) and UPF (113) to which the UE (111) belongs from the OAM.

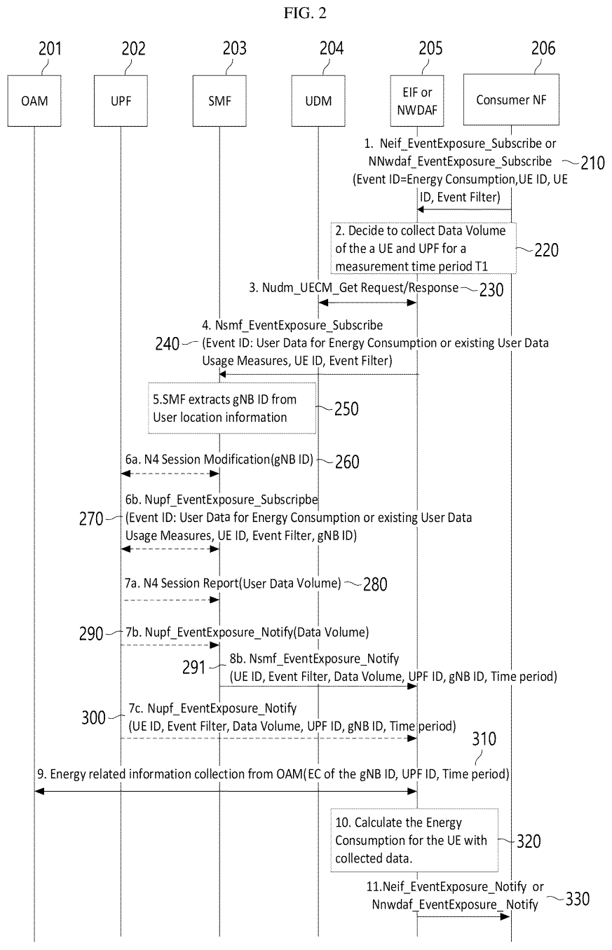

Referring to FIG. 2, a procedure for collecting data for energy consumption measurement of measurement target information according to an embodiment of the present disclosure is illustrated.

A Consumer Network Function (Consumer NF) (206) can subscribe to energy consumption event exposure services through the Energy Information Function Event Exposure Subscribe (Neif_EventExposure_Subscribe) or Network Data Analytics Function Event Exposure Subscribe (Nnwdaf_EventExposure_Subscribe) service operation to the Energy Information Function (EIF) (205) or Network Data Analytics Function (NWDAF) (205) including measurement target information to calculate energy consumption (EC) according to the measurement target information (210). According to one embodiment, the measurement target information consists of a UE identifier (UE ID) and event filter (Event Filter), and the event filter may include at least one of Data Network Name (DNN), Single-Network Slice Selection Assistance Information (S-NSSAI), Application Identifier (Application ID), Area of Interest (AoI), or Target Packet Flow information.

The EIF (205) or NWDAF (205) can decide to collect user data volume(s) and additional information during a specific period for energy consumption calculation (EC Calculation) of the measurement target information (220). According to one embodiment, the EIF (205) and NWDAF (205) can find the Session Management Function (SMF) (203) that manages the measurement target information through the Unified Data Management (UDM) (204) (230).

The EIF (205) or NWDAF (205) can subscribe to the SMF event (e.g., Event Identifier: Data for Energy Consumption or existing User Data Usage Measures) through the SMF Event Exposure Subscribe (Nsmf_EventExposure_Subscribe) service operation, including the UE identifier and event filter, to request collection of user data volume(s) and additional information needed for energy consumption calculation of the measurement target information from the SMF (203) (240).

Upon receiving this, the SMF (203) can check the event identifier, recognize that it is an event for energy consumption data collection, and then extract the gNB identifier (gNB ID) from the user location information already received from the Access and Mobility Management Function (AMF) through the PDU Session Establishment procedure (250).

The SMF (203) can request the User Plane Function (UPF) (202) using the N4 Session Modification Request message of the Packet Forwarding Control Protocol (PFCP) (260) or subscribe to the UPF event (e.g., Event Identifier: Data for Energy Consumption or existing User Data Usage Measures) through the UPF Event Exposure Subscribe (Nupf_EventExposure_Subscribe) service operation to obtain user data volume(s) of the measurement target information (270). According to one embodiment, the SMF (203) may include the UE identifier, event filter, gNB identifier, and measurement time information.

The UPF (202) measures the user data volume(s) of the measurement target information based on the information received from the SMF (203), and then reports to the SMF (203) including the user data volume(s) and additional information using the N4 Session Report message (280) or through the UPF Event Exposure Notify (Nupf_EventExposure_Notify) service operation (290). Subsequently, the SMF (203) can notify the EIF (205) of the measurement target information, user data volume(s), and additional information through the SMF Event Exposure Notify (Nsmf_EventExposure_Notify) (e.g., Event Identifier: Data for Energy Consumption or existing User Data Usage Measures) service operation (291).

The UPF (202) can also directly notify the EIF (205) or NWDAF (205) of the user data volume(s) and additional information of the measurement target information through the UPF Event Exposure Notify (Nupf_EventExposure_Notify) service operation as instructed by the SMF (203) (300).

The EIF (205) or NWDAF(205) can subscribe to the OAM event exposure service through the service operation to collect the total energy consumption of gNB and UPF (202) to which the UE of the measurement target information belongs during the measurement time information from the Operation Administration Maintenance (OAM) (201), and the OAM (201) can send the total energy consumption of the gNB and UPF (202) corresponding to the gNB identifier and UPF identifier, along with the measurement time information of the resultand the gNB identifier and UPF identifier, to the EIF (205) or NWDAF(205) using the service operation (310).

The EIF (205) calculates the final energy consumption amount for the measurement time of the measurement target information using the user data volume(s) and additional information of the measurement target information related to the UE received from the SMF (203) or UPF (202) during the same measurement time information, and the total energy consumption for the gNB identifier and UPF identifier from the OAM (201) (320), and transmits the total energy consumption of the measurement target information to the Consumer NF (206) through the service operation (330).

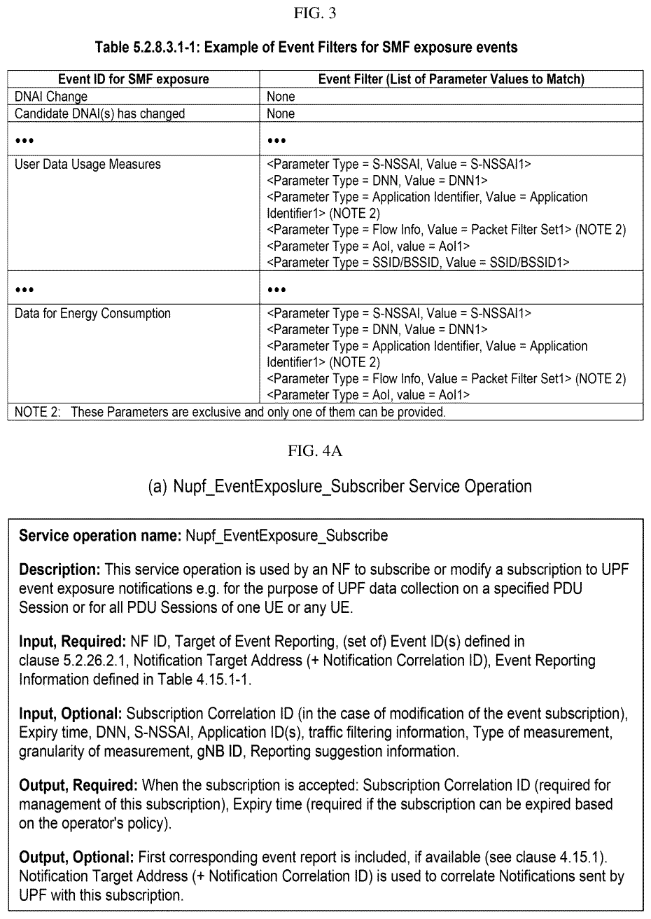

Referring to FIG. 3, event identifiers (Event IDs) and event filter information for SMF Event Exposure according to an embodiment of the present disclosure are illustrated.

An event filter table for SMF exposure events is shown. According to one embodiment, the present disclosure can use either the existing User Data Usage Measures event or a new Data for Energy Consumption event.

When using the new Data for Energy Consumption event, the applicable event filters may include at least one of Single-Network Slice Selection Assistance Information (S-NSSAI), Data Network Name (DNN), Application Identifier, Packet Flow Info, or Area of Interest (AoI). According to one embodiment, as indicated in the note (NOTE 2) of the table, the Application Identifier and Packet Flow Info parameters are mutually exclusive, so only one of them can be provided.

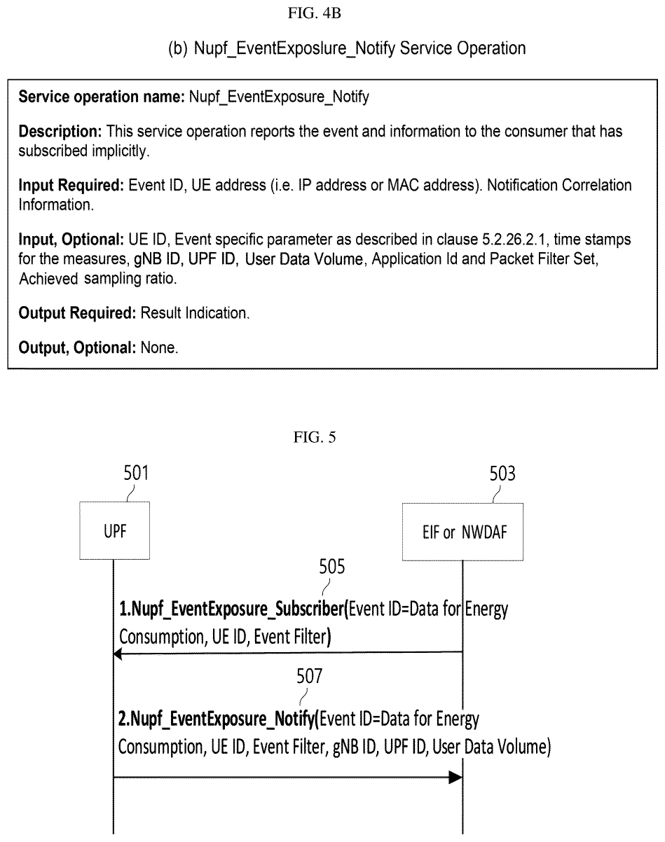

Referring to FIG. 4A and FIG. 4B, UPF event exposure service operations with additional information for UE energy consumption measurement according to an embodiment of the present disclosure are illustrated.

Specifically, FIG. 4A illustrates the UPF Event Exposure Subscribe (Nupf_EventExposure_Subscribe) service operation, and FIG. 4B illustrates the UPF Event Exposure Notify (Nupf_EventExposure_Notify) service operation.

As shown in FIG. 4A, a gNB identifier (gNB ID) has been added to the optional input parameters of the UPF Event Exposure Subscribe service operation. The present disclosure can provide additional information necessary for UE energy consumption measurement by adding the gNB identifier (ID) to the UPF Event Exposure Subscribe service operation.

As shown in FIG. 4B, the optional input of the UPF Event Exposure Notify service operation may include UE identifier (UE ID), event-specific parameter, time stamps, gNB identifier (gNB ID), UPF identifier (UPF ID), user data volume(s), Application Id, and Packet Filter Set. The present disclosure can provide additional information necessary for ULE energy consumption measurement by including at least one of gNB identifier, UPF identifier, or user data volume(s) in the UPF Event Exposure Notify service operation.

Through these UPF event exposure service operations, the present disclosure can efficiently provide the necessary additional information for UE energy consumption measurement.

Referring to FIG. 5, a direct UPF event exposure service processing procedure for UE energy consumption measurement according to an embodiment of the present disclosure is illustrated.

A direct event exposure service processing procedure between the User Plane Function (UPF) (501) and the Energy Information Function (EIF) or Network Data Analytics Function (NWDAF) (503) is shown.

The EIF or NWDAF (503) can directly subscribe to events with the UPF (501) including the measurement target information to collect user data volume(s) and additional information needed for energy consumption calculation (EC Calculation) of the measurement target information. Specifically, the EIF or NWDAF (503) can subscribe to events with the Event ID being Data for Energy Consumption, including the UE identifier (UE ID) and event filter (Event Filter), measurement time information through the UPF Event Exposure Subscribe (Nupf_EventExposure_Subscribe) service operation (505).

The UPF (501) can directly transmit the result information to the EIF or NWDAF (503) through the UPF Event Exposure Notify (Nupf_EventExposure_Notify) service operation (507). The information transmitted includes the UE identifier, event filter, gNB identifier (gNB ID), UPF identifier (UPF ID), and user data volume(s) for the event with the event identifier being Data for Energy Consumption.

Through this direct UPF event exposure service processing procedure, the present disclosure allows the EIF or NWDAF to directly collect data necessary for energy consumption measurement of measurement target information from the UPF, thereby streamlining the data collection process.

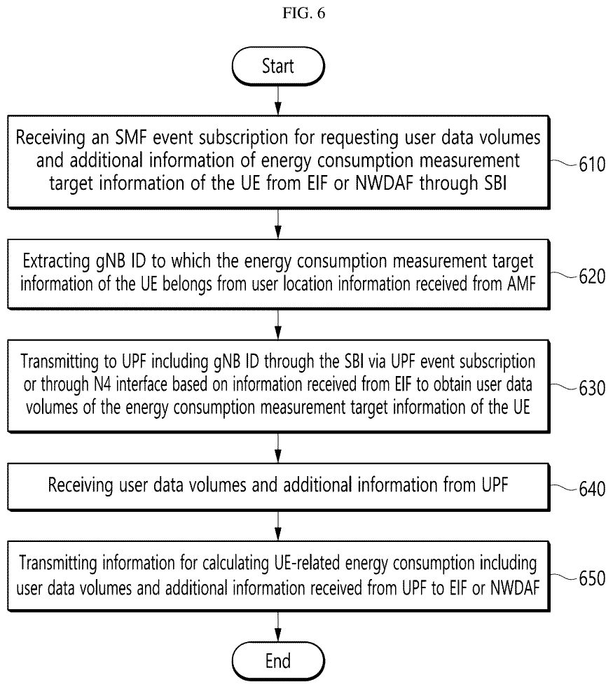

Referring to FIG. 6, a flowchart illustrating a method of operating a Session Management Function (SMF) for measuring energy consumption of a user equipment (UE) in a wireless communication system according to an embodiment of the present disclosure is shown.

The SMF receives an SMF event subscription for requesting user data volume(s) and additional information of energy consumption measurement target information from the Energy Information Function (EIF) or Network Data Analytics Function (NWDAF) through a Service Based Interface (SBI) (610). According to one embodiment, the SMF event subscription may include an event identifier (Event ID) and measurement target information, where the event identifier may be either Data for Energy Consumption or User Data Usage Measure. Additionally, the measurement target information may consist of a UE identifier (UE ID) and event filter (Event Filter), and the event filter may include at least one of Data Network Name (DNN), Single-Network Slice Selection Assistance Information (S-NSSAI), Application Identifier (Application ID), Area of Interest (AoI), or Target Packet Flow Information.

The SMF extracts a gNB identifier (gNB ID) to which the energy consumption measurement target information belongs from user location information received from the Access and Mobility Management Function (AMF) (620). According to one embodiment, the SMF can extract the gNB identifier (ID) from user location information already received from the AMF through the PDU Session Establishment procedure.

The SMF transmits to the User Plane Function (UPF) through the SBI via UPF event exposure service subscription or through the N4 (PFCP) interface based on information received from the EIF to obtain user data volume(s) of the energy consumption measurement target information (630). According to one embodiment, the UPF event subscription that the SMF transmits to the UPF can be done through the UPF Event Exposure Subscribe (Nupf_EventExposure_Subscribe) service operation and may include UE identifier, event filter, gNB identifier, and measurement time information. Additionally, transmission through the N4 interface can use the N4 Session Modification Request message.

The SMF receives user data volume(s) and additional information from the UPF (640). According to one embodiment, the UPF measures the user data volume of the measurement target information based on the information received from the SMF, and then reports the user data volume(s) and additional information to the SMF through the N4 Session Report message or UPF Event Exposure Notify (Nupf_EventExposure_Notify) service operation.

The SMF transmits information for calculating UE-related energy consumption including the user data volume(s) and additional information received from the UPF to the EIF or NWDAF (650). According to one embodiment, the SMF can notify the EIF or NWDAF of the measurement target information, user data volume(s), and additional information through the SMF Event Exposure Notify (Nsmf_EventExposure_Notify) service operation. The additional information may include at least one of gNB ID, UPF ID, or measurement time information.

Through the method according to the present disclosure, the SMF can play an important role in the data collection process for UE energy consumption measurement. In particular, the SMF can relay necessary information between the EIF or NWDAF and UPF, and extract the gNB identifier using location information received from the AMF, enabling accurate energy consumption measurement.

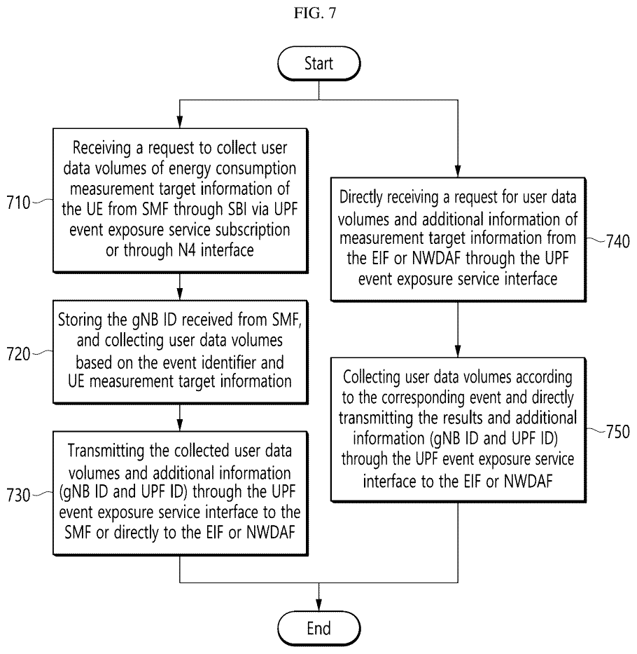

Referring to FIG. 7, a flowchart illustrating a method of operating a User Plane Function (UPF) for measuring energy consumption of a user equipment (UE) in a wireless communication system according to an embodiment of the present disclosure is shown.

The UPF receives a request to collect user data volume(s) of energy consumption measurement target information from the Session Management Function (SMF) through a Service Based Interface (SBI) via UPF event exposure service subscription or through an N4 interface (710). According to one embodiment, the UPF event subscription can be done through the UPF Event Exposure Subscribe (Nupf_EventExposure_Subscribe) service operation and may include an event identifier (Event ID), measurement target information, and gNB ID. The event identifier may be either Data for Energy Consumption or User Data Usage Measure. Additionally, reception through the N4 interface can be done through the N4 Session Modification Request message.

The UPF collects user data volume(s) using the event identifier, measurement target information, and gNB identifier (gNB ID) received from the SMF (720). According to one embodiment, the measurement target information may consist of a UE identifier (UE ID) and event filter (Event Filter), and the event filter may include at least one of Data Network Name (DNN), Single-Network Slice Selection Assistance Information (S-NSSAI), Application Identifier (Application ID), Area of Interest (AoI), or Target Packet Flow Information.

The UPF transmits the collected user data volume(s) and additional information through the UPF event exposure service interface to the SMF or directly to the EIF or NWDAF according to the information received from the SMF (730). According to one embodiment, the UPF can transmit the collected user data volume(s) and additional information through the UPF Event Exposure Notify (Nupf_EventExposure_Notify) service operation. The additional information may include at least one of gNB identifier, UPF identifier, or measurement time information.

Additionally, the UPF can directly receive a request for user data volume(s) and additional information of the measurement target from the EIF or NWDAF through the UPF event exposure service interface, including the event identifier and measurement target information (740).

Subsequently, the UPF can collect the user data volume(s) for the corresponding event and directly transmit the results to the EIF or NWDAF through the UPF event exposure service interface (750). According to one embodiment, the UPF can receive a direct request from the EIF or NWDAF through the UPF Event Exposure Subscribe (Nupf_EventExposure_Subscribe) service operation, and the UPF can directly transmit the collected user data volume(s) and additional information through the UPF Event Exposure Notify (Nupf_EventExposure_Notify) service operation. The additional information may include at least one of gNB identifier, UPF identifier, or measurement time information.

In this case, direct communication with the EIF or NWDAF is possible without going through the SMF. This direct communication method can simplify the data transfer process and improve efficiency.

Through the method according to the present disclosure, the UPF can play a key role in the data collection process for UE energy consumption measurement. As a network function that processes actual data traffic, the UPF can measure accurate user data volume(s) and provide them to the SMF or EIF/NWDAF, contributing to energy efficiency improvement in 5G systems. In particular, the advantage is that the UPF supports both indirect communication through the SMF and direct communication with the EIF/NWDAF, allowing for flexible responses depending on the network situation.

According to various embodiments of the present disclosure, a method for measuring UE energy consumption (EC) in a 5G system (5GS) includes: the SMF (Session Management Function) receiving an SMF event subscription for requesting Data Volume(s) and additional information of the UE energy consumption (EC) measurement target information from the EIF (Energy Information Function) or NWDAF (Network Data Analytics Function) through the SBI (Service Based Interface); the SMF extracting the gNB ID to which the energy consumption measurement target information belongs from the User location information received from the AMF (Access and Mobility Management Function); the SMF transmitting to the UPF (User Plane Function) through the SBI including the gNB ID via UPF event subscription or through the N4 (PFCP: Packet Forwarding Control Protocol) interface based on information received from the EIF to obtain User Data Volume(s) of the energy consumption measurement target information; the UPF collecting user data volume(s) using the Event ID, measurement target information, and gNB ID, measurement time information received from the SMF and transmitting the results and additional information through the Nupf_EventExposure service interface to the SMF or directly to the EIF or NWDAF; the SMF transmitting the User Data Volume(s) and additional information received from the UPF for UE energy consumption calculation to the EIF; the UPF directly receiving a request for user data volume(s) and additional information of the measurement target information from the EIF or NWDAF through the Nupf_EventExposoure service interface and directly transmitting the User Data Volume(s) and additional information of the measurement target information according to the corresponding event through the Nupf_EventExposure service interface to the EIF or NWDAF.

According to one embodiment, the SMF event and UPF event subscription may include an Event ID (e.g., Event ID: Data for Energy Consumption or existing User Data Usage Measure) and measurement target information.

According to one embodiment, the measurement target information consists of UE ID and Event Filter, and the Event Filter may include one or more of DNN, S-NSSAI, Application ID, AoI (Area of Interest), or Target Packet flow information.

According to one embodiment, the additional information that the SMF receives from the EIF or NWDAF and that the SMF or UPF responds to the EIF or NWDAF may include one or more of gNB ID, UPF ID(s), or measurement time information.

According to one embodiment, the SMF event subscription that the SMF receives from the EIF or NWDAF is the Nsmf_EventExposure_Subscribe service operation, and the SMF event notification that is sent to the EIF or NWDAF is the Nsmf_EventExposure_Notify.

According to one embodiment, the UPF event subscription that the UPF receives from the SMF is the Nupf_EventExposure_Subscribe service operation, and the UPF event notification that is sent to the SMF, EIF, or NWDAF is the Nupf_EventExposure_Notify.

According to one embodiment, the N4 interface may be either an N4 Session Modification message or an N4 Session Report.

Hereinafter, the present disclosure illustrates a method and apparatus for managing the User Plane Function and Network Repository Function for enhancing energy efficiency in the 5G System (5GS).

The User Plane Function (UPF) in the 5GS also needs additional functions for enhancing energy efficiency. In particular, since not all UPFs support energy efficiency enhancement functions, the UPF needs to inform other NFs that it has energy efficiency enhancement functions to help other NFs when selecting UPFs that support these functions.

Therefore, the present disclosure provides a method for a UPF with energy efficiency enhancement capabilities to inform the SMF and NRF(Network Repository Function) of these capability information and related additional information when it is initially deployed and operational.

Specifically, the present disclosure relates to a method for managing the UPF and NRF for enhancing energy efficiency in the 5G System (5GS). More specifically, it relates to a method that allows other NFs (Network Functions) to easily discover UPFs with network energy efficiency enhancement functions in the 5G system by having the UPF provide capability information and related additional information about its energy efficiency enhancement processing functions to the SMF and NRF.

For this purpose, the present disclosure makes it easier for the SMF to find UPFs with energy efficiency enhancement functions by including energy efficiency enhancement capability information and related additional information in the Association Setup procedure that exchanges information about each function's supported capabilities and related information through the existing N4 interface between SMF and UPF.

Additionally, when a UPF initially registers its UPF profile with the NRF, the UPF registers energy efficiency enhancement capability information and related additional information with the NRF. Later, when other NFs (e.g., SMF, EIF or NWADF) want to find UPFs with energy efficiency enhancement functions, they can easily discover such UPFs by including energy efficiency enhancement support and related additional information in their discovery requests to the NRF.

Through the present disclosure, a UPF with energy efficiency enhancement functions can provide energy efficiency enhancement capability information and related information to the SMF and NRF initially, allowing other NFs to easily discover UPFs with energy efficiency enhancement functions and directly subscribe to UPF events for energy efficiency enhancement.

The existing procedures and information exchanged regarding the initial Association Setup through the N4 interface between SMF and UPF are described in detail in TS 29.244 V18.4.0 (2023-12) sections 6.2.5˜6.3.3 and 7.4.4. Basically, the control plane (CP) function SMF (801) and user plane (UP) function UPF (803) can exchange their respective supported function capabilities along with the start time and other necessary information.

Also, in the Service Based Architecture (SBA) structure, all network functions (NFs) can initially register the services they can provide with the Network Repository Function (NRF). And consumer network functions (Consumer NFs) that want to use the services provided by the registered NFs can discover NFs that have the desired services through the NRF.

The existing UPF service profile registration procedure and the procedure for other network functions (NFs) to discover UPFs supporting the needed services through the NRF are described in detail in 3GPP TS23.502 18.4.0 (2023-12) document sections 4.17.1˜4.17.5.

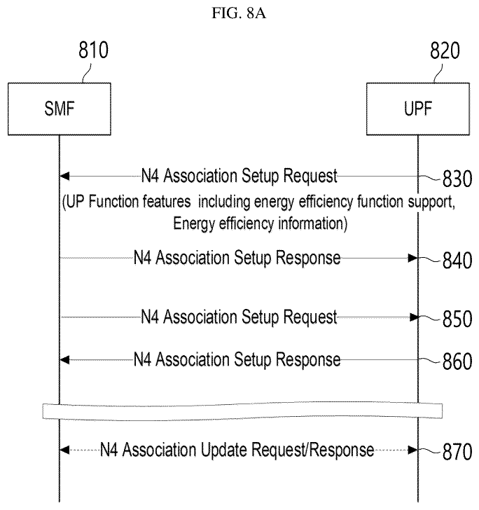

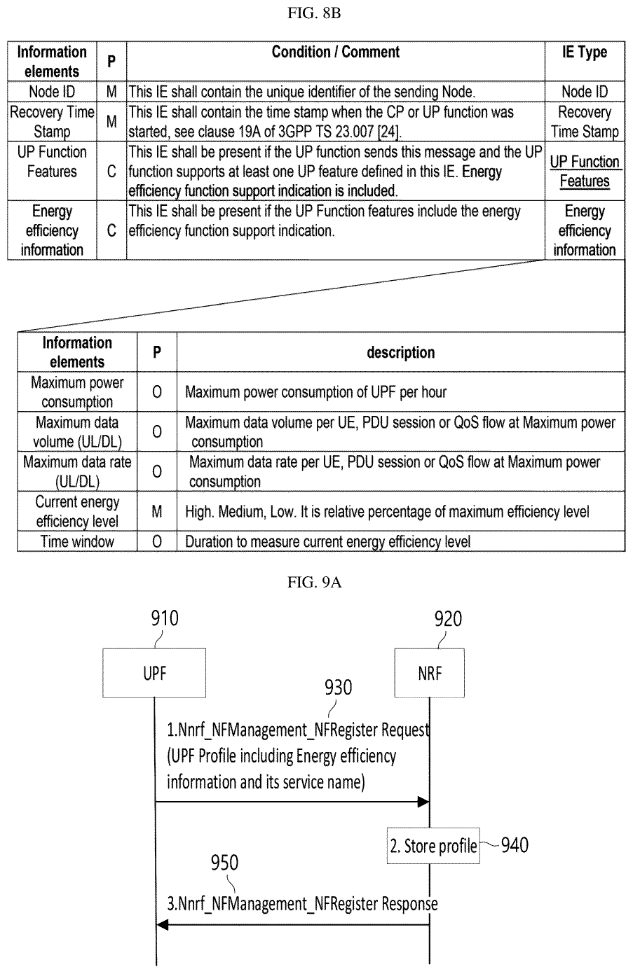

Referring to FIG. 8A, an initialization procedure between UPF and SMF including energy efficiency enhancement function support information according to an embodiment of the present disclosure is illustrated.

The initial Association Setup procedure through the N4 interface between SMF (810) and UPF (820) is shown. The procedure in FIG. 8A includes the process of a UPF with energy efficiency enhancement functions informing the SMF of its support for these functions and related information.

The UPF (820) can transmit an N4 Association Setup Request message to the SMF (810) (830). According to one embodiment, the N4 Association Setup Request message indicates support for energy efficiency enhancement functions in the UP Function features, and if the function is supported, additional Energy Efficiency Information may be included. This additional information can serve to inform the SMF about the UPF's energy efficiency-related characteristics.

The SMF (810) can transmit an N4 Association Setup Response message to the UPF (820) (840). The N4 Association Setup Response message may include confirmation of receipt of the UPF's energy efficiency enhancement function support information.

The SMF (810) can transmit an N4 Association Setup Request message to the UPF (820) (850), and the UPF (820) can transmit an N4 Association Setup Response message to the SMF (810) in response (860). Subsequently, N4 Association Update Request/Response messages may be exchanged between the SMF (810) and UPF (820) as needed (870).

The energy efficiency additional information provided by the UPF in the 860 and 870 step of the FIG. 8A is described in detail in FIG. 8B.

Through this initialization procedure, the SMF can understand the UPF's energy efficiency enhancement function support and related information, and based on this, make session management decisions considering network energy efficiency.

Referring to FIG. 8B, energy efficiency enhancement function related information elements exchanged in the initialization procedure between UPF and SMF according to an embodiment of the present disclosure are illustrated.

The information elements exchanged through the N4 interface between UPF and SMF during the initial Association Setup procedure are shown in table format. The upper table in FIG. 8B includes Information elements, Presence (P), Condition/Comment, and IE Type, while the lower table shows detailed items of energy efficiency related additional information.

The upper table includes information elements such as Node ID, Recovery Time Stamp, UP Function Features, and Energy efficiency information. According to one embodiment, UP Function Features is a conditional (C) element that must be present if the UP function sends this message and the UP function supports one or more of the UP functions defined in this IE. In particular, it includes an Energy efficiency function support indication.

Energy efficiency information is also a conditional (C) element that must be present if the UP Function Features includes the Energy efficiency function support indication. This means that a UPF with energy efficiency enhancement functions indicates its support for energy efficiency enhancement functions in the UPF Function feature, and if this function is supported, additional energy efficiency related information is included.

The lower table shows the detailed contents of energy efficiency related additional information, which may include the following items:
(1) Maximum power consumption: An optional (O) element that may indicate the power consumption per hour required for full functionality operation and maximum packet transmission without considering the UPF's energy efficiency.
(2) Maximum data volume (UL/DL): An optional (O) element that may indicate the maximum transmittable data volume per UE, PDU session, or QoS flow at maximum power consumption.
(3) Maximum data rate (UL/DL): An optional (O) element that may indicate the maximum transmission bit rate per UE, PDU session, or QoS flow.
(4) Current energy efficiency level: A mandatory (M) element that indicates the energy efficiency level during the recent Time window, which can be displayed as High, Medium, or Low. For example, this can be determined by relative power consumption compared to maximum power consumption.
(5) Time window: An optional (O) element that may indicate the period for measuring the current energy efficiency level.

Through these information elements, the UPF can inform the SMF of its energy efficiency enhancement function support and detailed information, and the SMF can make session management decisions considering network energy efficiency based on this information.

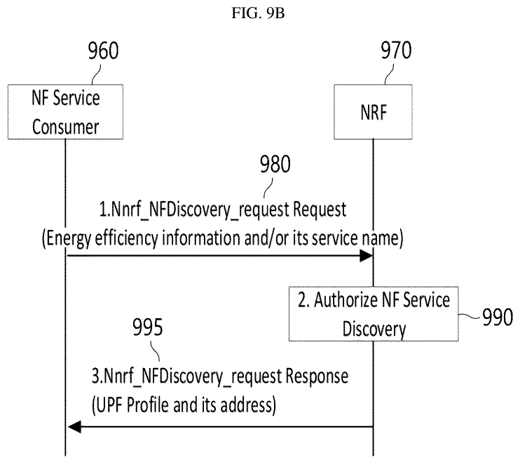

Referring to FIG. 9A, a registration procedure of a User Plane Function (UPF) with energy efficiency enhancement functions with the Network Repository Function (NRF) according to an embodiment of the present disclosure is illustrated.

The UPF service profile registration procedure between UPF (910) and NRF (920) is shown. The procedure in FIG. 9A demonstrates the process when a UPF has and supports energy efficiency enhancement functions, registering this information with the NRF.

The UPF (910) can transmit an Nnrf_NFManagement_NFRegister Request message to the NRF (920) to register its UPF profile (930). According to one embodiment, the Nnrf_NFManagement_NFRegister Request message may include a UPF service profile containing energy efficiency related information and service names in addition to the information elements included in the conventional UPF service registration. The additional energy efficiency related information may be identical to the information transmitted between UPF and SMF in FIG. 8A and FIG. 8B.

The NRF (920) can store the profile information received from the UPF (910) (940). In operation (940), the NRF can store the UPF's identifier, provided services, supported functions, or energy efficiency enhancement related information in its database.

After storing the profile, the NRF (920) can transmit an Nnrf_NFManagement_NFRegister Response message to the UPF (910) to confirm the registration completion (950). The Nnrf_NFManagement_NFRegister Response message may include registration success status and related information.

The information elements included in the conventional UPF service profile registration are described in detail in 3GPP TS23.501 18.4.0 (2023-12) document section 5.2.7.2, and in the present disclosure, an Indication of energy efficiency support and Energy efficiency information are added here. For energy efficiency related information, refer to the explanation of FIG. 8B.

After this registration procedure, when another consumer network function (Consumer NF) wants to discover a UPF that provides energy efficiency enhancement functions, it can request discovery by including energy efficiency enhancement related information or service names (which could be event types) in addition to the information elements included in the conventional procedure. Subsequently, the NRF can find UPFs that support energy efficiency enhancement functions among the registered UPFs and send the results to the Consumer NF.

Through this UPF service profile registration procedure, other network functions in the 5G system can efficiently discover and use UPFs that support energy efficiency enhancement functions through the NRF.

Referring to FIG. 9B, a procedure between a Consumer Network Function (Consumer NF) and a Network Repository Function (NRF) for discovering a User Plane Function (UPF) that provides energy efficiency enhancement functions according to an embodiment of the present disclosure is illustrated.

The UPF discovery procedure between a Consumer Network Function (960) and NRF (970) is shown. The procedure in FIG. 9B demonstrates the process of another consumer network function discovering UPFs that provide energy efficiency enhancement functions after the UPF service profile registration procedure in FIG. 9A.

The Consumer Network Function (960) can transmit an Nnrf_NFDiscovery_request Request message to the NRF (970) to request UPF discovery (980). According to one embodiment, the Nnrf_NFDiscovery_request Request message may include energy efficiency enhancement information or service names (which could be event types) in addition to the information elements included in the conventional UPF discovery request. The information included in the Nnrf_NFDiscovery_request Request message may be an Indication of energy efficiency support and Energy efficiency information. The information included in the Nnrf_NFDiscovery_request Request message may be identical to the information transmitted between UPF and SMF in FIG. 8A and FIG. 8B.

The NRF (970) authorizes the NF service discovery (990) and can search among the registered UPFs for those that support energy efficiency enhancement functions. In this process, the NRF can use the previously stored UPF profile information to select suitable UPFs that support energy efficiency enhancement functions.

The NRF (970) can transmit an Nnrf_NFDiscovery_request Response message with the search results to the Consumer Network Function (960) (995). According to one embodiment, this response message may include profile information of UPFs that support energy efficiency enhancement functions and the addresses of those UPFs.

The information elements included in the conventional UPF discovery request are described in detail in 3GPP TS23.501 18.4.0 (2023-12) document section 5.7.7.3, and in the present disclosure, an Indication of energy efficiency support and Energy efficiency information are added here. For energy efficiency information, refer to the explanation of FIG. 8B.

Through this UPF discovery procedure, the consumer network function can efficiently find UPFs that provide the energy efficiency enhancement functions it needs, thereby contributing to the overall energy efficiency enhancement of the 5G system.

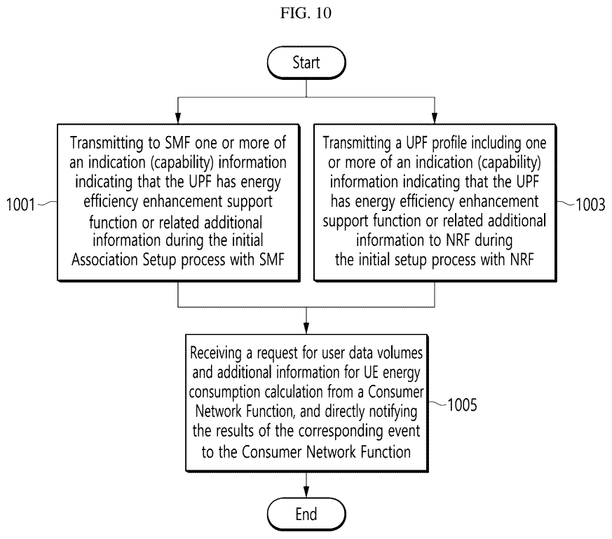

Referring to FIG. 10, a flowchart illustrating a method for the User Plane Function (UPF) to support energy efficiency enhancement and energy saving of the network in a 5G system (5GS) according to an embodiment of the present disclosure is shown.

The flow of the energy efficiency enhancement method performed by the UPF is illustrated.

The UPF can transmit the UPF's energy efficiency enhancement indication and energy efficiency information to the Session Management Function (SMF) during the initial Association Setup process (1001). According to one embodiment, operation (1001) can be performed through the Association setup procedure shown in FIG. 8A and FIG. 8B. The UPF can indicate its support for energy efficiency enhancement functions in the UP Function Features, and if the function is supported, additionally include Energy Efficiency Information.

Additional information may include the following items: (1) Maximum power consumption of the UPF: This can indicate the power consumption per hour required for operating all functions and maximum packet transmission without considering the UPF's energy efficiency. (2) Maximum data volume (UL/DL): This can indicate the maximum transferable data amount per UE, PDU session, or QoS flow at maximum power consumption. (3) Maximum data rate (UL/DL): This can indicate the maximum transmission bit rate per UE, PDU session, or QoS flow. (4) Current energy efficiency level: This indicates the energy efficiency level during the recent Time window, which can be displayed as High, Medium, or Low. (5) Time window: This can indicate the period for measuring the current energy efficiency level.

Additionally, the UPF can register UPF profile information including an energy efficiency enhancement support indication (Indication of energy efficiency support) and energy efficiency information with the Network Repository Function (NRF) (1020). According to one embodiment, this step can be performed through the UPF service profile registration procedure shown in FIG. 9A. The UPF can register its UPF profile with the NRF through the Nnrf_NFManagement_NFRegister Request message, which may include the same information as transmitted between UPF and SMF in FIG. 8.

The UPF can receive a request for user data volume(s) and additional information needed for energy consumption calculation from a Consumer Network Function through the SMF or directly, and notify the results to the SMF or directly to the Consumer Network Function (1005). According to one embodiment, operation (1005) can be performed through the data collection procedure for energy consumption calculation shown in FIG. 2.

The Consumer Network Function can request the UPF for related events to calculate energy consumption of the UE's energy measurement target information in two ways:

In the first method, it requests the SMF using the SMF event exposure service, the SMF forwards this to the UPF, and then the UPF can notify the event results to the SMF or directly to the Consumer Network Function through the Nupf_EventExposure_Notify message.

In the second method, it directly requests energy efficiency enhancement events to the UPF, and the UPF can directly notify the results of the corresponding events to the Consumer Network Function through the Nupf_EventExposure_Notify message.

According to one embodiment, the Consumer Network Function may be either the EIF or NWDAF.

Through this UPF energy efficiency enhancement support method, other network functions in the 5G system can identify and utilize the UPF's energy efficiency enhancement functions, thereby contributing to the overall energy efficiency enhancement and energy saving of the 5G system.

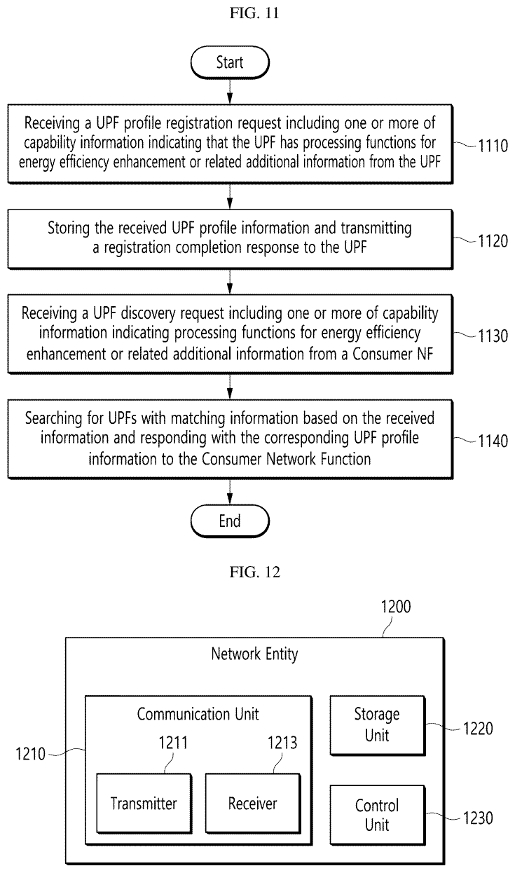

Referring to FIG. 11, a flowchart illustrating a method for the Network Repository Function (NRF) to support energy efficiency enhancement and energy saving of the network in a 5G system (5GS) according to an embodiment of the present disclosure is shown.

The flow of the energy efficiency enhancement support method performed by the NRF is illustrated.

The NRF can receive a request to register a UPF profile including at least one of an energy efficiency enhancement support indication or related additional information from a User Plane Function (UPF) (1110). According to one embodiment, operation (1110) can be performed through the UPF service profile registration procedure shown in FIG. 9A. The UPF can register its UPF profile with the NRF through the Nnrf_NFManagement_NFRegister Request message, which may include energy efficiency enhancement related information in addition to the information elements included in the conventional UPF service registration.

The energy efficiency information that may be included in the registration request may include the following items: (1) Maximum power consumption of the UPF: This can indicate the power consumption per hour required for operating all functions and maximum packet transmission without considering the UPF's energy efficiency. (2) Maximum data volume (UL/DL): This can indicate the maximum transferable data amount per UE, PDU session, or QoS flow at maximum power consumption. (3) Maximum data rate (UL/DL): This can indicate the maximum transmission bit rate per UE, PDU session, or QoS flow. (4) Current energy efficiency level: This indicates the energy efficiency level during the recent Time window, which can be displayed as High, Medium, or Low. (5) Time window: This can indicate the period for measuring the current energy efficiency level.

The NRF can store the received UPF profile information and transmit a registration completion response to the UPF (1120). According to one embodiment, in operation (1120), the NRF can store the received UPF's identifier, provided services, supported functions, or energy efficiency enhancement related information in its database. And the NRF can confirm the registration completion to the UPF through the Nnrf_NFManagement_NFRegister Response message.

The NRF can receive a UPF discovery request including an energy efficiency enhancement support indication and energy efficiency information from a Consumer Network Function (1130). According to one embodiment, operation (1130) can be performed through the UPF discovery procedure shown in FIG. 9B. The Consumer Network Function can transmit a request to discover UPFs that provide energy efficiency enhancement functions to the NRF through the Nnrf_NFDiscovery_request Request message. This request may include an energy efficiency enhancement support indication or service name (which could be an event type) in addition to the information elements included in the conventional UPF discovery request.

The NRF can search for UPFs with matching information based on the received information and respond with the profile information of these UPFs to the Consumer Network Function (1140). According to one embodiment, in operation (1440), the NRF can select UPFs that meet the requested energy efficiency enhancement function criteria among the registered UPFs. And the NRF can transmit the search results to the Consumer Network Function through the Nnrf_NFDiscovery_request Response message. This response message may include the profile information and addresses of UPFs that support energy efficiency enhancement functions.

Through this NRF energy efficiency enhancement support method, Consumer Network Functions can efficiently discover UPFs that provide the energy efficiency enhancement functions they need, which can lead to the procedure for collecting user data volume(s) and additional information for UE energy consumption measurement between the Consumer Network Function and UPF as shown in FIG. 2. Ultimately, these procedures can contribute to the overall energy efficiency enhancement and energy saving of the 5G system.

Referring to FIG. 12, a configuration of a network entity in a wireless communication system according to various embodiments of the present disclosure is illustrated. The network entity of the present disclosure may include the concept of a network function (network function) depending on the system implementation. The term ‘˜unit’, ‘˜part’, etc. used below refers to a unit that processes at least one function or operation, and may be implemented in hardware or software, or a combination of hardware and software.

The network entity (1200) according to various embodiments of the present disclosure may include a communication unit (1210), a storage unit (1220), and a control unit (1230) that controls the overall operation of the network entity (1200).

The communication unit (1210) transmits and receives signals with other network entities. Accordingly, all or part of the communication unit (1210) may be referred to as a ‘transmitter (1211)’, ‘receiver (1213)’, or ‘transceiver (1210)’.

The storage unit (1220) stores basic programs, application programs, setting information, and other data for the operation of the network entity (1200). The storage unit (1220) may be composed of volatile memory, non-volatile memory, or a combination of volatile memory and non-volatile memory. And the storage unit (1220) provides stored data according to the request of the control unit (1230).

The control unit (1230) controls the overall operations of the network entity (1200). For example, the control unit (1230) transmits and receives signals through the communication unit (1210). Additionally, the control unit (1230) writes and reads data in the storage unit (1220). And the control unit (1230) can perform the functions required by the communication standard protocol stack. For this, the control unit (1530) may include a circuit, an application-specific circuit, at least one processor or microprocessor, or may be part of a processor. Additionally, part of the communication unit (1510) and the control unit (1530) may be referred to as a CP (communication processor).

The control unit (1230) may control the network entity (1200) to perform any of the various embodiments of the present disclosure. The communication unit (1210) and the control unit (1230) do not necessarily have to be implemented as separate modules, but may be implemented as a single component such as a single chip or software block. The communication unit (1210), storage unit (1220), and control unit (1230) may be electrically connected. Additionally, the operations of the network entity (1200) may be realized by equipping the storage unit (1220) that stores the corresponding program code within the network entity (1200).

The network entity (1200) includes network nodes and may be one of a base station (RAN), AMF, SMF, UPF, NF, NEF, NRF, PCF, NSSF, UDM, AF, AUSF, SCP, UDSF, NWDAF, EIF, DN, context storage, OAM, EMS, configuration server, ID (identifier) management server.

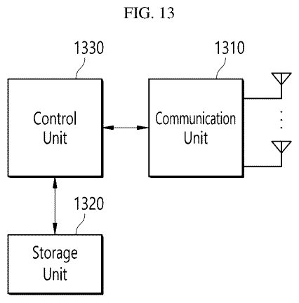

Referring to FIG. 13, a configuration of a user equipment in a wireless communication system according to various embodiments of the present disclosure is illustrated. The term ‘ . . . unit’, ‘ . . . part’, etc. used below refers to a unit that processes at least one function or operation, and may be implemented in hardware or software, or a combination of hardware and software.

Referring to FIG. 13, the user equipment may include a communication unit (1310), a storage unit (1320), and a control unit (1330).

The communication unit (1310) may perform functions for transmitting and receiving signals through a wireless channel. For example, the communication unit (1310) may perform conversion functions between baseband signals and bit sequences according to the physical layer specification of the system. For example, when transmitting data, the communication unit (1310) may generate complex symbols by encoding and modulating a transmission bit sequence. When receiving data, the communication unit (1310) may restore a reception bit sequence through demodulation and decoding of a baseband signal. Additionally, the communication unit (1310) may upconvert a baseband signal to an RF band signal and transmit it through an antenna, and downconvert an RF band signal received through the antenna to a baseband signal. For example, the communication unit (1310) may include a transmission filter, reception filter, amplifier, mixer, oscillator, DAC, ADC, etc.

Additionally, the communication unit (1310) may include multiple transmission and reception paths. Furthermore, the communication unit (1310) may include at least one antenna array composed of multiple antenna elements. From a hardware perspective, the communication unit (1310) may be composed of digital circuits and analog circuits (e.g., RFIC (radio frequency integrated circuit)). Here, the digital circuits and analog circuits may be implemented as a single package. Additionally, the communication unit (1310) may include multiple RF chains. Furthermore, the communication unit (1310) may perform beamforming.

The communication unit (1310) transmits and receives signals as described above. Accordingly, all or part of the communication unit (1310) may be referred to as a ‘transmitter’, ‘receiver’, or ‘transceiver’. Additionally, in the following description, transmission and reception performed through a wireless channel may be used in a sense that includes processing as described above by the communication unit (1310).

The storage unit (1320) may store basic programs, application programs, setting information, and other data for the operation of the user equipment. The storage unit (1320) may be composed of volatile memory, non-volatile memory, or a combination of volatile memory and non-volatile memory. And the storage unit (1320) may provide stored data according to the request of the control unit (1330).

The control unit (1330) may control the overall operations of the user equipment. For example, the control unit (1330) may transmit and receive signals through the communication unit (1310). Additionally, the control unit (1330) may write and read data in the storage unit (1320). The control unit (1330) may perform the functions required by the communication standard protocol stack. For this, the control unit (1330) may include at least one processor or microprocessor, or may be part of a processor. Additionally, part of the communication unit (1310) and the control unit (1330) may be referred to as a CP (communication processor).

According to various embodiments, the control unit (1330) may control the user equipment to perform the operations according to the various embodiments described below.

The methods according to the embodiments described in the claims or specification of the present disclosure can be implemented in the form of hardware, software, or a combination of hardware and software.

When implemented in software, one or more programs (software modules) can be provided in a computer-readable storage medium. One or more programs stored in the computer-readable storage medium are configured for execution by one or more processors within an electronic device. One or more programs include instructions that cause the electronic device to execute the methods according to the embodiments described in the claims or specification of the present disclosure.

These programs (software modules, software) can be stored in random access memory, non-volatile memory including flash memory, read only memory (ROM), electrically erasable programmable read only memory (EEPROM), magnetic disk storage device, compact disc-ROM (CD-ROM), digital versatile discs (DVDs), or other forms of optical storage devices, magnetic cassettes. Or, they can be stored in memory composed of a combination of some or all of these. Additionally, each constituent memory may be included in multiple numbers.

Additionally, programs can be stored in attachable storage devices that can be accessed through communication networks such as the Internet, Intranet, local area network (LAN), wide area network (WAN), or storage area network (SAN), or a combination of these. Such storage devices can connect to the device performing the embodiments of the present disclosure through an external port. Additionally, a separate storage device on a communication network may also connect to the device performing the embodiments of the present disclosure.

In the specific embodiments of the present disclosure described above, the components included in the disclosure have been expressed in singular or plural according to the specific embodiments presented. However, the singular or plural expression is chosen appropriately for the situation presented for convenience of explanation, and the present disclosure is not limited to singular or plural components. Components expressed in plural may be configured in singular, or components expressed in singular may be configured in plural.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents.

What is claimed is:

1. A method of operating a Session Management Function (SMF) for measuring energy consumption (EC) of a user equipment (UE) in a wireless communication system, the method comprising:
receiving, from an Energy Information Function (EIF) or Network Data Analytics Function (NWDAF) through a Service Based Interface (SBI), an SMF event subscription for requesting user data volume(s) and additional information of energy consumption measurement target information of the UE;
extracting a gNodeB (gNB) ID to which the energy consumption measurement target information belongs from user location information received from an Access and Mobility Management Function (AMF);
transmitting to a User Plane Function (UPF) including the gNB ID through the SBI via UPF event subscription or through an N4 (Packet Forwarding Control Protocol, PFCP) interface based on information received from the EIF to obtain user data volume(s) of the energy consumption measurement target information;
receiving user data volume(s) and the additional information from the UPF; and
transmitting the information received from the UPF for calculating UE-related energy consumption to the EIF or the NWDAF.

2. The method of claim 1, wherein the SMF event subscription includes an event identifier (Event ID) and the measurement target information, and the event identifier is one of Data for Energy Consumption or User Data Usage Measure.

3. The method of claim 1, wherein the measurement target information consists of UE identifier (UE ID) and event filter (Event Filter), and the event filter includes at least one of DNN (Data Network Name), S-NSSAI (Single-Network Slice Selection Assistance Information), application identifier (Application ID), area of interest (Area of Interest, AoI), or Target Packet Flow Information.

4. The method of claim 1, wherein the additional information includes at least one of gNB identifier (gNodeB ID), UPF identifier (UPF ID), or measurement time information.

5. The method of claim 1, wherein the SMF event subscription that the SMF receives from the EIF or the NWDAF is an SMF event exposure subscribe (Nsmf_EventExposure_Subscribe) service operation, and the SMF event notification that is sent to the EIF or the NWDAF is an SMF event exposure notify (Nsmf_EventExposure_Notify) service operation.

6. A method of operating a User Plane Function (UPF) for measuring energy consumption (EC) of a user equipment (UE) in a wireless communication system, the method comprising:
receiving, from a Session Management Function (SMF) through a Service Based Interface (SBI) via UPF event exposure service subscription or through an N4 (Packet Forwarding Control Protocol, PFCP) interface, a request to collect user data volume(s) of energy consumption measurement target information of the UE;
collecting user data volume(s) using an event identifier (Event ID), measurement target information, and a gNodeB (gNB) identifier (ID) received from the SMF;
transmitting the user data volume(s) and additional information through a UPF event exposure (Nupf_EventExposure) service interface to the SMF or directly to an Energy Information Function (EIF) or Network Data Analytics Function (NWDAF); and
directly receiving a request for user data volume(s) and additional information of the measurement target information from the EIF or NWDAF through the UPF event exposure service interface, collecting user data volume(s) according to the event, and directly transmitting the results through the UPF event exposure service interface to the EIF or NWDAF.

7. The method of claim 6, wherein the UPF event subscription includes an event identifier (Event ID) and the measurement target information, and the event identifier is one of Data for Energy Consumption or User Data Usage Measure.

8. The method of claim 6, wherein the measurement target information consists of UE identifier (UE ID) and event filter (Event Filter), and the event filter includes at least one of DNN (Data Network Name), S-NSSAI (Single-Network Slice Selection Assistance Information), application identifier (Application ID), area of interest (Area of Interest, AoI), or target flow information Target Packet Flow Information.

9. The method of claim 6, wherein the additional information includes at least one of gNB identifier (gNodeB ID), UPF identifier (UPF ID), or measurement time information.

10. The method of claim 6, wherein the UPF event subscription that the UPF receives from the SMF is a UPF event exposure subscribe (Nupf_EventExposure_Subscribe) service operation, and the UPF event notification that is sent to the SMF, the EIF, or the NWDAF is a UPF event exposure notify (Nupf_EventExposure_Notify) service operation.

11. An SMF (Session Management Function) for measuring energy consumption of a user equipment in a wireless communication system, comprising:
a transceiver; and
a controller operably connected to the transceiver, wherein the controller is configured to:
receive, from an Energy Information Function (EIF) or Network Data Analytics Function (NWDAF) through a Service Based Interface (SBI), an SMF event subscription for requesting user data volume(s) and additional information of energy consumption measurement target information of the UE;
extract a gNodeB (gNB) ID to which the energy consumption measurement target information belongs from user location information received from an Access and Mobility Management Function (AMF);
transmit to a User Plane Function (UPF) including the gNB ID through the SBI via UPF event subscription or through an N4 (Packet Forwarding Control Protocol, PFCP) interface based on information received from the EIF to obtain user data volume(s) of the energy consumption measurement target information;
receive user data volume(s) and the additional information from the UPF; and
transmit the information received from the UPF for calculating UE-related energy consumption to the EIF or the NWDAF.

12. The SMF of claim 11, wherein the SMF event subscription includes an event identifier (Event ID) and the measurement target information, and the event identifier is one of Data for Energy Consumption or User Data Usage Measure.

13. The SMF of claim 11, wherein the measurement target information consists of UE identifier (UE ID) and event filter (Event Filter), and the event filter includes at least one of DNN (Data Network Name), S-NSSAI (Single-Network Slice Selection Assistance Information), application identifier (Application ID), area of interest (Area of Interest, AoI), or Target Packet Flow Information.

14. The SMF of claim 11, wherein the additional information includes at least one of gNB identifier (gNodeB ID), UPF identifier (UPF ID), or measurement time information.

15. The SMF of claim 11, wherein the SMF event subscription that the SMF receives from the EIF or the NWDAF is an SMF event exposure subscribe (Nsmf_EventExposure_Subscribe) service operation, and the SMF event notification that is sent to the EIF or the NWDAF is an SMF event exposure notify (Nsmf_EventExposure_Notify) service operation.
